(19) United States
(12) Patent Application Publication
(10) Pub. No.: US 2026/0288215 A1
(43) Pub. Date: Sep. 24, 2026

(54) Double Detection of Power and Thermal Configuration

(71) Applicant: Dell Products L.P., Round Rock, TX (US)

(72) Inventors: Steven Michael Christensen, Austin, TX (US); Chun-Che Wang, Hsinchu City (TW)

(73) Assignee: Dell Products L.P., Round Rock, TX (US)

(21) Appl. No.: 19/086,060

(22) Filed: Mar. 20, 2025

(51) Int. Cl. G06F 1/20

(52) U.S. Cl. CPC G06F 1/206

(57) ABSTRACT

A motherboard includes a power switch connection and a cooling system connection. A component detection circuit determines whether a chassis configuration is correct based on signals from the power switch and cooling system connections. The system includes a motherboard controller with inputs coupled to pins on the power switch and cooling system connectors, each connected to a pull-high circuit. This configuration allows the detection of different power switch and cooling system types, enabling the system BIOS to evaluate these signals and determine the appropriate chassis configuration.

### BACKGROUND

Information Handling Systems (IHS) generally process, compile, store, and/or communicate information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use. In addition, information handling systems may include a variety of hardware and software components that may be configured to process, store, and communicate information and may include one or more computer systems, data storage systems, and networking systems.

IHSs are generally built from a wide variety of components. Selecting components to include within an information handling system helps end users target the capabilities of the information handling system for planned tasks. Typically, an information handling system has a motherboard that couples to a chassis to support communication between information handling system components. A typical motherboard is a printed circuit board (PCB) that has one or more central processing unit (CPU) sockets to accept one or more CPUs for executing instructions. The CPU sockets interface through the motherboard with memory sockets that hold memory for storing information in support of executing instructions, such as DIMM sockets that hold DRAM modules. The motherboard can interface with a variety of other components, such as an embedded controller, a network interface module, a graphics processor and other types of chipset components supported by the motherboard that perform processing functions. Generally, components interface through the motherboard using standardized communications links, such as a PCI or PCIe bus.

In some instances, processing functions are performed by components located off the motherboard, such as components supported by daughterboards or option modules. Option modules typically include a PCB with function-specific components, such as graphics components or network communication components. Option modules generally include an interface that provides communication with the motherboard through the motherboard's communications link, such as a PCI or PCIe bus. By distributing functions to option modules, an IHS provides end users with greater flexibility for the selection of components. For example, a graphics subsystem built on an option module will typically provide more effective graphics processing than the graphics components included with a chipset coupled to a motherboard. As another example, a server adjusts to interface with local area networks and/or storage networks by inserting appropriate option modules for the desired interfaces.

### SUMMARY

Embodiments are directed to systems and methods for double detection of the thermal solution used in an IHS chassis.

In one embodiment, an information handling system includes a motherboard having a power switch connection and a cooling system connection. Detection circuitry is configured to determine a chassis configuration based on signals from the power switch and cooling system connections. The detection circuitry includes a motherboard controller with an input coupled through a pull-high circuit to a pin on the power switch connector so that a voltage-high signal is received when a first type of power switch is attached and a voltage-low signal is received when a second type is attached. The detection circuitry further includes an input coupled through a pull-high circuit to a pin on the cooling system connector, wherein the input is configured to provide a voltage-high signal when a first cooling system type is attached and a voltage-low signal when a second cooling system type is attached. The system BIOS evaluates these signals and determine the appropriate chassis configuration.

In another embodiment, a method for booting an information handling system includes reading a power switch type signal from the motherboard and retrieving a model flag value from nonvolatile memory, determining whether the power switch type signal corresponds to the model flag value, and allowing the boot process to continue if a match is found. In some embodiments, the method further includes reading a cooling system type signal from the motherboard and determining whether there is a match with the model flag value, enabling the boot process to proceed when the signals correspond. In other embodiments, if the cooling system type signal does not match the model flag value, the method includes posting a message to indicate that an incorrect cooling system is installed and halting the boot process, or alternatively, adjusting the model flag value, setting chassis parameters such as a model number and fan control to align with the detected power switch type, and initiating a reboot. In certain embodiments, the power switch and cooling system type signals are monitored by a motherboard controller with dedicated inputs coupled through pull-high circuits that yield a voltage-high signal for standard attachments and a voltage-low signal for alternative attachments.

These and additional features will be more fully appreciated in the detailed description.

### BRIEF DESCRIPTION OF THE DRAWINGS

Having thus described the invention in general terms, reference will now be made to the accompanying drawings, which are not necessarily drawn to scale, and wherein:

FIG. 1 illustrates an example printed circuit board assembly (PCBA) that may be configured to work with different IHS chassis architectures.

FIGS. 2A and 2B illustrate system architectures for use with various power switch cables.

FIG. 3 is an example IHS architecture illustrating how a standard motherboard may be adapted for use in a high-temperature system using a remote switch cable.

FIG. 4 is block diagram of an example circuit for detecting when a system has been configured for high-temperature operation.

FIG. 5 is a flowchart illustrating a BIOS workflow process for determining whether a system is in a high-temperature configuration.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

Various architectures may be used for different IHSs, such as different configurations designed for specific use cases, performance requirements, and spatial constraints. The dimensions of an IHS chassis vary for the different architectures, which affects how the IHS components are arranged and installed in the chassis. Example architectures include, for example, full tower, mid tower, mini tower, small form factor, and horizontal/desktop form factor. The specific IHS components, such as CPUs, GPUs, memory, storage, fans or other cooling solutions, etc., depend on the user's needs, available space, performance demands, and upgradeability. An IHS chassis will often have a baseline configuration that allows for additional features and capabilities using expansion slots.

Printed Circuit Board Assemblies (PCBA) serve as the foundation for electronic circuits in IHS systems. The PCBAs consist of a Printed Circuit Board (PCB) that is populated with electronic components such as processors, microchips, resistors, capacitors, and connectors that enable a desired functionality. The PCBA provides power distribution, data pathways, and control signals for the various components mounted on the PCB. PCBAs provide functionality for graphics cards (GPUs), power supply units, storage devices such as solid state devices (SSDs) and hard disk drives (HDDs), networking components such as network interface cards (NICs), modems, and routers, and fan and cooling systems. The PCBAs form the backbone of the IHS and enable the integration and operation of essential components. The PCBA may be a motherboard or may be part of an option module/daughtercard that connects to the motherboard directly or through an expansion slot.

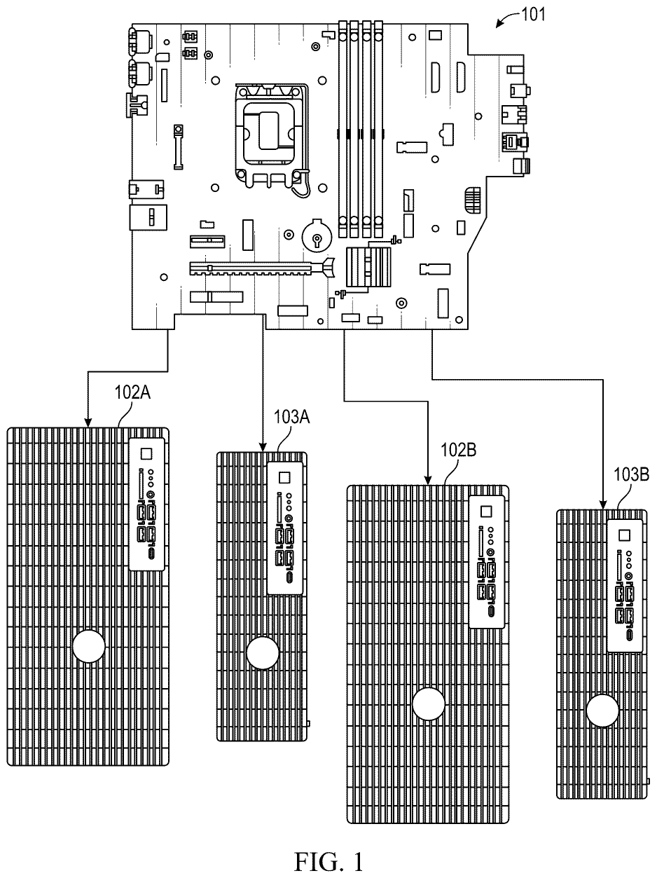

As illustrated in FIG. 1, a PCBA 101 may be configured to work with different IHS chassis architectures 102, 103. This allows customers to order an IHS chassis 102 or 103 that fits their needs and to take advantage of specific features and functionality provided by PCBA 101. For example, system 102 may be a mini tower architecture, and system 103 may be a small form factor architecture. The PCBA 101 is typically installed at the factory during manufacture but may also be added later during a service call. It is important for the IHS to know the chassis type in which the PCBA has been installed. This may be required for model tracking, configuring input/output setting and for cooling system control algorithms. Alternatively, a PCBA may be configured only in a particular chassis type or group of chassis. In that case, it is important to detect whether the PCBA has been installed in the wrong chassis.

When the IHS is powered on after PCBA 101 install, the BIOS (Basic Input/Output System) or UEFI (Unified Extensible Firmware Interface) runs a Power-On Self-Test (POST). During POST, the IHS checks for new hardware, such as RAM, storage devices, expansion cards, and PCBA 101. The IHS scans for devices connected to the Peripheral Component Interconnect Express (PCIe) bus or to expansion slots. The BIOS/UEFI assigns system resources to a new PCBA 101, such as I/O ports, memory addresses, Interrupt Requests (IRQ), and DMA channels if required. Once the Operating System (OS) boots up, it queries the PCI bus and identifies the newly installed PCBA 101. The OS then loads the appropriate driver for the PCBA 101 as needed and initializes the PCBA 101.

A particular chassis architecture may be used for systems with different capabilities. For example, chassis 102a and 103a may be standard mini tower and small form factor systems, while chassis 102b and 103b are high-temperature systems using the same tower and small form factor architecture as chassis 102a and 103a, respectively. The various architectures 102a,b and 103a,b are configured to share the same PCBAs 101 among the standard systems 102a, 103a and the high-temperature systems 102b, 103b. In one configuration, the high-temperature systems 102b, 103b have cooling systems that are designed to handle higher ambient operating temperatures. These high-temperature cooling systems are generally more expensive and ordered less frequently by customers compared to standard systems for operation at lower ambient temperatures with cost-optimized CPU thermal solutions.

In one arrangement, the high-temperature systems 102b, 103b also require a remote power capability that is not found on the standard systems 102a, 103a. For example, a remote cable is plugged into a high-temperature system that is deployed inside of a kiosk, where the power switch needs to be external to a locked kiosk. In legacy systems, remote power functionality was included by adding an extra connector on the motherboard and running traces to an extra connector within the PCB. In a configuration where PCBAs 101 can be leveraged by many different architectures 102a,b and 103a,b, etc., large numbers of PCBAs 101 that are used in standard systems 102a, 103a do not need the extra remote power features. Instead, the remote power feature may be dedicated only to high-temperature systems 102b, 103b. Also, additional PCB real estate is made available by removing the extra connector and associated traces that are the required to support the remote feature from the PCB traces.

Because the same motherboard is used between standard systems 102a, 103a (with the majority of sales) and specialized high-temperature systems 102b, 103b, the motherboard PCBA 101 can be modified to be optimized for the high-volume standard systems. The configuration includes: removing the remote power capability and associated cost from the standard configurations, removing the PCB traces needed for the remote power switch able to optimize the PCBA cost and features for the standard systems, and providing a highly accurate method to detect whether a chassis has been correctly manufactured as a standard system or a high-temperature system so that the correct CPU cooler components and remote power capability are included as necessary.

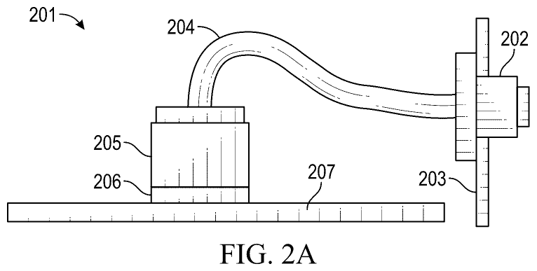

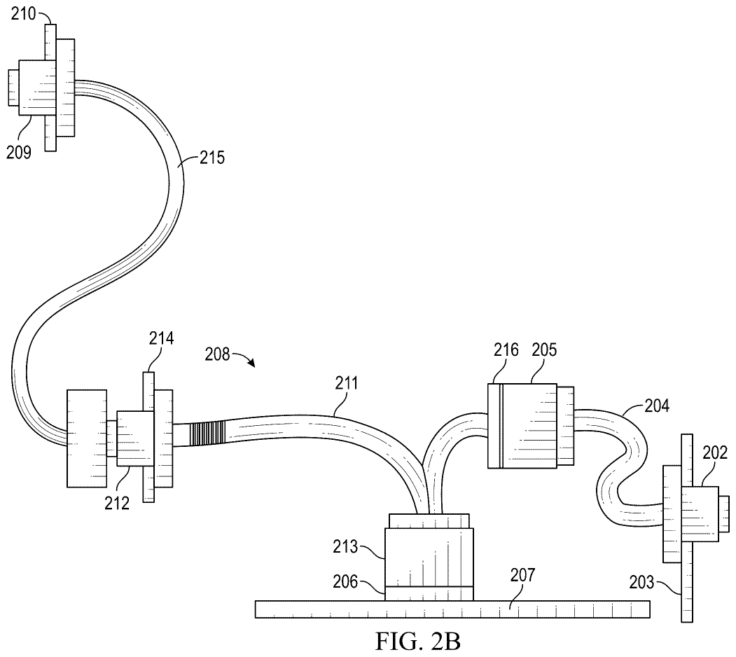

FIGS. 2A and 2B illustrate changes to a system architecture to use a remote power switch cable. A standard system chassis 201 (FIG. 2A) has a power switch 202 on the front chassis wall 203. A standard power switch cable 204 couples the front power switch 202 to a power switch connector 205 that is adapted to fit a power switch header 206 on motherboard 207. The system shown in FIG. 2A is the standard system, which will comprise the majority of customer sales. Accordingly, because most users will not need a high-temperature configuration, there is no need for motherboard 207 to include traces for a remote switch.

FIG. 2B shows a high-temperature configuration 208 that may be required by some users. The high-temperature configuration 208 requires a remote power switch capability to accommodate use cases where the system 208 will be locked in an enclosure, such as a rack, kiosk, or cabinet, that generally does not allow a user access to front power switch 202 on front chassis wall 203. Instead, users of the high-temperature system 208 require a remote power switch. In one configuration, a remote power switch 209 is mounted on an enclosure wall, such as a kiosk wall 210. In the illustrated configuration, a remote power switch cable 211 couples a rear chassis connector 212 to a power switch connector 213. The rear chassis connector 212 is mounted on rear chassis wall 214. The power switch connector 213 is adapted to fit the power switch header 206 on motherboard 207. An external power cable 215 is coupled between the rear chassis connector 212 and the remote power switch 209.

Remote power switch cable 211 also has a front power switch connector 216 that mimics power switch header 206. The front power switch connector 216 provides a connection for the power switch connector 205 on a standard power switch cable 204. This allows both the front power switch 202 and a remote power switch 209 to interact with motherboard 207.

In other embodiments, an external power cable 215 may not be required, such as when a system 208 is deployed so that rear chassis wall 214 is exposed to a user. In that case, the rear chassis connector 212 may be replaced with the remote power switch 209.

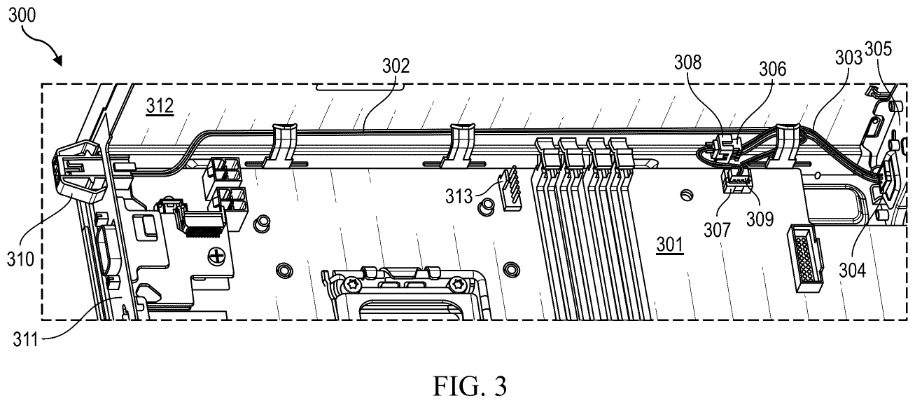

FIG. 3 is an example IHS architecture 300 illustrating how a standard motherboard 301 may be adapted for use in a high-temperature system using a remote switch cable 302. Motherboard 301 does not include PCB traces or other components that support a remote power switch since that feature is used infrequently. Instead, when a user requires a high-temperature configuration, the standard switch cable 303 is supplemented by remote switch cable 302. One end of standard switch cable 303 is connected to power switch 304, which is mounted on the front chassis wall 305. The other end of standard switch cable 303 has a connector 306, which is adapted to fit power switch header 307 on motherboard 301.

In the high-temperature configuration, instead of attaching connector 306 of the standard switch cable 303 to power switch header 307, connector 306 is attached to a front switch connector 308 on remote switch cable 302. The remote switch cable 302 also includes a connector 309 that is adapted to fit the power switch header 307. This provides a connection between front power switch 304 and the motherboard 301 via cables 303, 302.

The remote switch cable 302 further includes a remote switch adapter 310. This may be a remote power switch or a connection to additional cabling that is attached to a remote power switch (e.g., if the remote power switch is located beyond rear chassis wall 311). Remote switch cable 302 may be routed along chassis side wall 312, which leaves additional space open on motherboard 301 for other uses.

In one configuration, a remote switch detect pin on power switch header 307 is used to detect whether remote switch cable 302 or standard switch cable 303 is connected to the motherboard 301. In a normal operating condition, the remote switch detect pin is a pulled-high design that normally generates a voltage-high signal. When the standard switch cable 303 is attached to power switch header 307, the remote switch detect pin remains at the voltage-high signal. However, when the remote switch cable 302 is attached to power switch header 307, the remote switch detect pin is pulled-low to a voltage-low signal (e.g., connected to ground at zero voltage). Motherboard 301 can monitor the voltage signal on the remote switch detect pin to determine when the remote switch cable 302 has been attached, which means that the motherboard may need to operate in a high-temperature condition.

Motherboard 301 also includes a cooling system header 313 that is used to power a thermal module for cooling the CPU. The cooling system header 313 may be used with different thermal modules designed for various configurations. For example, one thermal module may be used for a standard system and another thermal module used for a high-temperature system.

A thermal module detect pin is used on cooling system header 313 to detect whether a high-temperature thermal module has been connected to motherboard 301. In a normal operating condition, the thermal module detect pin is a pulled-high design that normally generates a voltage-high signal. When a standard thermal module is attached to cooling system header 313, the thermal module detect pin remains at the voltage-high signal. However, when the high-temperature thermal module is attached to cooling system header 313, the thermal module detect pin is pulled-low to a voltage-low signal (e.g., connected to ground at zero voltage). Motherboard 301 can monitor the voltage signal on the thermal module detect pin to determine when a high-temperature thermal module has been attached.

As discussed above, the cost and PCB space required to support a remote power feature is removed from the motherboard and replaced with a cable that integrates with the connector used for a standard front power switch. The remote power switch cable includes a detection circuit that provides a signal to the system BIOS telling it that the system is configured as a high-temperature system. Additionally, the cooling system also has a detect signal that lets BIOS know that it is high-temperature system with high-temperature cooler and not a standard cooler. Combining both circuit detections of the remote power switch cable and the cooling system provides double-detection logic for the BIOS to ensure that the high-temperature system has been properly configured. If the system is not correctly configured, such as if the combination of cable detection and cooling system detection is not correct, then the BIOS can then signal a factory assembler, service personnel, or customer regarding the error.

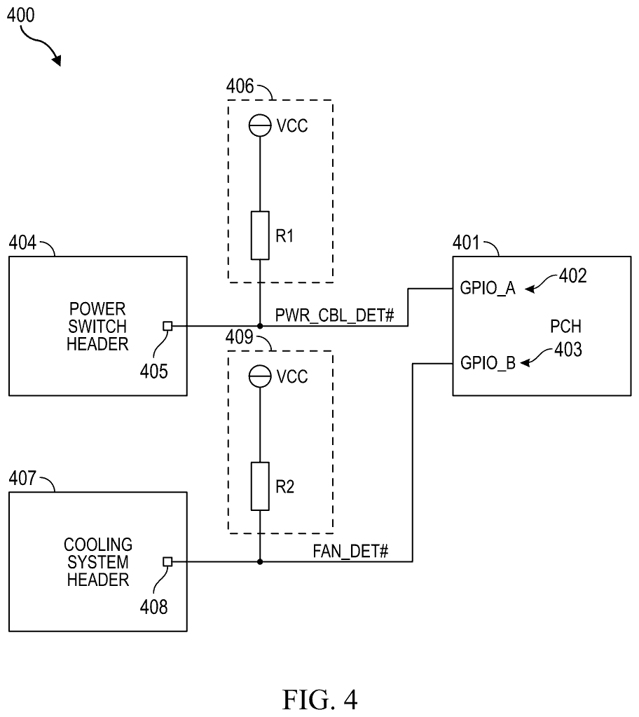

FIG. 4 is block diagram of an example circuit 400 for detecting when a system has been configured for high-temperature operation. A motherboard controller, such as a Platform Controller Hub (PCH) 401, receives two General Purpose Input/Output (GPIO) inputs 402 and 403. GPIO 402 is coupled to a power switch header 404, such as power switch header 307 on motherboard 301. In particular, GPIO 402 is coupled to a remote switch detect pin 405 on the power switch header 404. GPIO 402 is also coupled to a bias circuit 405 that is configured to generate a voltage-high signal (i.e., pulled-high). The combination of the inputs from the remote switch detect pin on power switch header 404 and the signal from pull-high circuit 405 provides a power switch cable detection signal (PWR_CBL_DET #) input to GPIO 402.

During operations in a standard configuration, without a remote switch attached, the remote switch detect pin 405 provides no signal. Accordingly, during standard operations the input at GPIO 402 is the pulled-high signal from bias circuit 406. However, when a remote switch cable is installed, which is associated with high-temperature operations, the remote switch detect pin 405 is grounded, which forces the input to GPIO 402 to a voltage-low signal.

GPIO 403 is coupled to a cooling system header 407, such as cooling system header 313 on motherboard 301. In particular, GPIO 407 is coupled to a thermal module detect pin 408 on the cooling system header 407. GPIO 403 is also coupled to a bias circuit 409 that is configured to generate a voltage-high signal (i.e., pulled-high). The combination of the inputs from the thermal module detect pin 408 and the signal from pull-high circuit 409 provides a cooling system detection signal (FAN_DET #) input to GPIO 403.

PCH 401 monitors the inputs to GPIO 402 and GPIO 403 and determines whether the system is in a high-temperature configuration. This information may be passed on to system BIOS during a boot process.

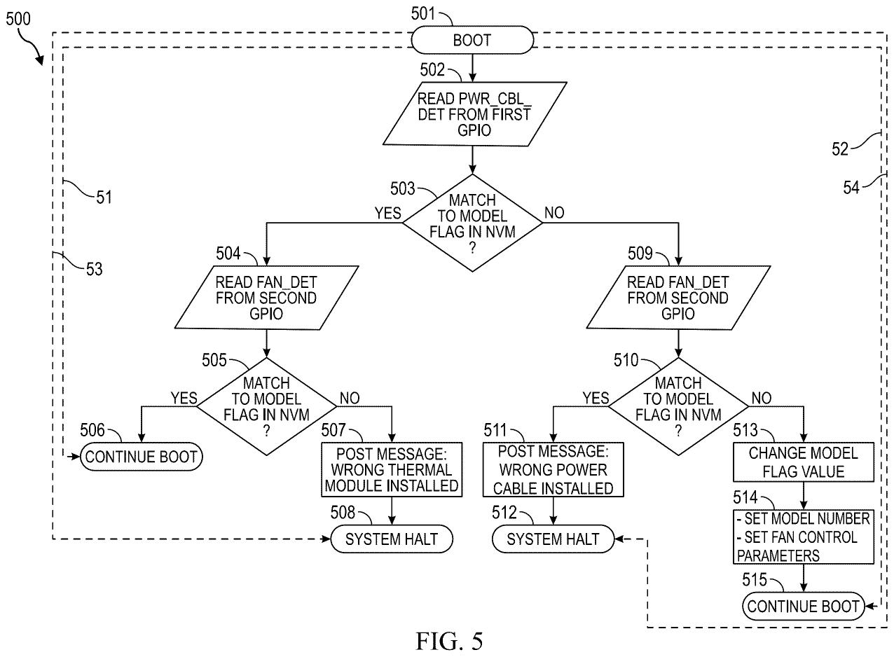

FIG. 5 is a flowchart illustrating a process 500 for determining whether a chassis configuration (i.e., the installed power cable and thermal module) is consistent with a model flag read by a system BIOS (i.e., a standard system or a high-temperature system). The BIOS reads GPIO signals, such as from a power switch header 404 and a cooling system header 407 to determine the chassis configuration.

Process 500 may flow along one of four paths. Path 51 represents a system in which the chassis configuration matches the expected model (e.g., the power cable and thermal module are correctly paired and match the model flag). Path 52 represents a system in which the power cable and thermal module are correctly paired but those components are a mismatch to the model flag. Paths 53 and 54 represent systems in which the power cable and the thermal module mismatched.

In step 501, an IHS is turned on and begins a boot process. In step 502, the BIOS reads a power cable detection signal from a first GPIO. The power cable detection signal may be equated to power cable type (e.g., high signal=standard power cable, low signal=remote power cable). In step 503, the detected power cable type from step 502 is compared to a model flag stored in nonvolatile memory (NVM). The model flag indicates whether the IHS is in a standard chassis or a high-temperature chassis. If the detected power cable type matches the stored model flag (i.e., the installed power cable is in the expected chassis type), then the boot process continues at step 504.

At step 504, the BIOS reads a cooling system detection signal at a second GPIO. The cooling system detection signal indicates a cooling system type (e.g., high signal=standard thermal module, low signal=high-temperature thermal module). In step 505, the detected cooling system type from step 504 is compared to the model flag stored in nonvolatile memory. If the detected cooling system type matches the model flag, then the boot process continues at step 506. This path 51 is expected when the detected component combination was either (1) a standard power cable remote and a standard thermal module or (2) a remote power cable and a high-temperature thermal module, and the combination matches the model flag.

Returning to step 505, if the detected cooling system type does not match the model flag, then the process continues at step 507. This would indicate that a mismatch was detected between the power cable type and the thermal module type based on the model flag (i.e., the correct power cable was detected, but thermal module is a mismatch). At step 507, the BIOS posts a warning message indicating that the wrong thermal module has been installed. This may be an alert to a current user who executed the boot. After issuing the warning in step 507, then the boot process halts at step 508 to prevent thermal damage to system components.

Referring again to step 503, if the detected power cable type does not match the stored model flag, then the process continues at step 509 where the BIOS reads the cooling system detection signal at the second GPIO. In step 510, the detected cooling system type from step 509 is compared to the model flag stored in nonvolatile memory.

If the detected cooling system type matches the model flag at step 510, then the boot process continues at step 511. This branch also indicates a mismatch was detected between the power cable type and the thermal module type based on the model flag (i.e., the wrong power cable was detected, but the correct thermal module was detected). At step 511, the BIOS posts a warning message indicating that the wrong power cable has been installed. This may be an alert to a current user who executed the boot. After issuing the warning in step 511, then the boot process halts at step 512 to prevent thermal damage to system components.

Alternatively at step 510, if the detected cooling system type does not match the model flag, then the boot process continues at step 513. This would indicate that the detected combination was either (1) a standard power cable remote and a standard thermal module or (2) a remote power cable and a high-temperature thermal module but that the model flag was set to the opposite system type (i.e., model flag indicates a high-temperature system when pair (1) detected, or model flag indicates a standard system when pair (2) detected). In step 513, the BIOS changes the stored model flag in NVM to reflect the power cable/thermal module pair actually detected. In step 514, the BIOS then sets updated configuration data, such as model number, fan control parameters, etc. The process then continues to step 515 and the boot process continues with the updated parameters. In other embodiments, the boot process may be restarted at step 515, which will cause the BIOS to return to step 501 and begin process 500 again. This restart would ensure that the parameters set at 514 take effect during the system start.

The embodiments disclosed herein provide a double-detect feature that ensures the correct configuration of system. The remote power cable design allows system detection from a single BIOS. Similarly, the CPU cooler connection to the motherboard allows for system detection from a single BIOS. Combined, these provide a hardware-enabled double-detect BIOS capability that ensures a particular cable type is installed in a particular system with a particular cooling system.

The remote power cable design provides BIOS and OS identification at a system level, thereby allowing use of a shared motherboard between the standard and high-temperature configurations. The remote power cable design eliminates the need for physical connectors, switches, or other devices on motherboard that add cost and potentially require manual setting. Moreover, the remote power cable design eliminates the cost of components that are only necessary for a lower volume configurations that use a leveraged PCBA motherboard. The remote power cable design saves space on a leveraged PCBA motherboard that otherwise would have been reserved for traces and components that are only necessary for the lower volume configurations. Removal of the traces and space allocation allows for a cost reduced PCBA motherboard or additional base configuration features.

The BIOS' double-detection operation eliminates the possibility of assembly error during manufacture or field servicing since a particular cable and cooling system combination is required on all high-temperature configurations. This eliminates the possibility of a wrong thermal module being installed in either the standard or high-temperature configurations.

Although the flowchart in FIG. 5 starts with reading the power cable detection signal and matching the power cable to the model flag (and then moves to the cooling system detection signal), it will be understood that in other configurations the BIOS process may instead check the cooling system detection signal first before moving to checking the power cable. Additionally, it will be understood that in other configurations different parameters may be checked in the system in addition to or in place of the power cable and the cooling system. For example, the BIOS may match a model flag to the presence or absence of certain CPUs, GPUs, hard disk drives, solid state drives, memory, RAM, ROM, ports, interfaces, modules, or other chassis configuration options.

In an example embodiment, an Information Handling System (IHS) comprises a motherboard, a power switch connection on the motherboard, a cooling system connection on the motherboard, and a component detection circuit coupled to the power switch connection and to the cooling system connection, the component detection circuit adapted to determine an IHS chassis configuration based upon signals from the power switch connection and the cooling system connection. The component detection system includes a motherboard controller, and an input on the motherboard controller that is coupled to a pin on the power switch connector and to a pull-high circuit. The input may be configured to receive a voltage-high signal when a first power switch type is attached to the power switch connection and to receive a voltage-low signal when a second power switch type is attached to the power switch connection.

The component detection system may include a motherboard controller, and an input on the motherboard controller that is coupled to a pin on the cooling system connector and to a pull-high circuit. The input may be configured to receive a voltage-high signal when a first cooling system type is attached to the cooling system connection and to receive a voltage-low signal when a second cooling system type is attached to the cooling system connection.

The component detection system may alternatively include a motherboard controller, a first input on the motherboard controller coupled to a pin on the power switch connector and to a first pull-high circuit, and a second input on the motherboard controller coupled to a pin on the cooling system connector and to a second pull-high circuit. The first input is configured to receive a voltage-high signal when a standard power switch cable is attached to the power switch connector and to receive a voltage-low signal when a remote power switch cable is attached to the power switch connector. The second input is configured to receive a voltage-high signal when a standard cooling system type is attached to the cooling system connector and to receive a voltage-low signal when a high-temperature cooling system type is attached to the cooling system connector.

The component detection circuit may include a system BIOS configured to evaluate the signals from the power switch connection and the cooling system connection and to determine the IHS chassis configuration based upon the signals.

In an example configuration, a method for booting an information handling system (IHS) includes reading a power switch type signal from a motherboard, retrieving a model flag value from nonvolatile memory in the IHS, determining whether the power switch type signal matches the model flag value, and allowing the IHS to continue a boot process if the power switch type signal matches the model flag value.

The method may include reading a cooling system type signal from the motherboard, determining whether the cooling system type signal matches the model flag value, and allowing the IHS to continue the boot process if the cooling system type signal matches the model flag value.

The method may include reading a cooling system type signal from the motherboard, determining that the cooling system type signal does not match the model flag value, posting a message indicating that an incorrect cooling system is installed, and halting the boot process.

The method may include changing a model flag value when the power switch type signal does not match the model flag value, setting IHS chassis parameters to match a detected power switch type, and initiating a reboot process. The IHS chassis parameters may comprise a model number and a fan control.

The power switch type signal may be read from a power switch connector on the motherboard. The cooling system type signal may be read from a cooling system connector on the motherboard. The power switch type signal and the cooling system type signal may be monitored by a motherboard controller. The motherboard controller may include a first input coupled to a pin on a power switch connector and to a first pull-high circuit, and a second input coupled to a pin on a cooling system connector and to a second pull-high circuit. The first input may be configured to receive a voltage-high signal when a standard power switch cable is attached to the power switch connector and to receive a voltage-low signal when a remote power switch cable is attached to the power switch connector. The second input may be configured to receive a voltage-high signal when a standard cooling system type is attached to the cooling system connector and to receive a voltage-low signal when a high-temperature cooling system type is attached to the cooling system connector.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. An Information Handling System (IHS), comprising:
a motherboard;
a power switch connection on the motherboard;
a cooling system connection on the motherboard; and
a component detection circuit coupled to the power switch connection and to the cooling system connection, the component detection circuit adapted to determine an IHS chassis configuration based upon signals from the power switch connection and the cooling system connection.

2. The IHS of claim 1, wherein the component detection system comprises:
a motherboard controller; and
an input on the motherboard controller coupled to a pin on the power switch connector and to a pull-high circuit.

3. The IHS of claim 2, wherein the input is configured to receive a voltage-high signal when a first power switch type is attached to the power switch connection and to receive a voltage-low signal when a second power switch type is attached to the power switch connection.

4. The IHS of claim 1, wherein the component detection system comprises:
a motherboard controller; and
an input on the motherboard controller coupled to a pin on the cooling system connector and to a pull-high circuit.

5. The IHS of claim 4, wherein the input is configured to receive a voltage-high signal when a first cooling system type is attached to the cooling system connection and to receive a voltage-low signal when a second cooling system type is attached to the cooling system connection.

6. The IHS of claim 1, wherein the component detection system comprises:
a motherboard controller;
a first input on the motherboard controller coupled to a pin on the power switch connector and to a first pull-high circuit; and
a second input on the motherboard controller coupled to a pin on the cooling system connector and to a second pull-high circuit.

7. The IHS of claim 6, wherein the first input is configured to receive a voltage-high signal when a standard power switch cable is attached to the power switch connector and to receive a voltage-low signal when a remote power switch cable is attached to the power switch connector.

8. The IHS of claim 6, wherein the second input is configured to receive a voltage-high signal when a standard cooling system type is attached to the cooling system connector and to receive a voltage-low signal when a high-temperature cooling system type is attached to the cooling system connector.

9. The IHS of claim 1, wherein the component detection circuit comprises a system BIOS configured to evaluate the signals from the power switch connection and the cooling system connection and to determine the IHS chassis configuration based upon the signals.

10. A method for booting an information handling system (IHS), comprising:
reading a power switch type signal from a motherboard;
retrieving a model flag value from nonvolatile memory in the IHS;
determining whether the power switch type signal matches the model flag value; and
allowing the IHS to continue a boot process if the power switch type signal matches the model flag value.

11. The method of claim 10, further comprising:
reading a cooling system type signal from the motherboard;
determining whether the cooling system type signal matches the model flag value; and
allowing the IHS to continue the boot process if the cooling system type signal matches the model flag value.

12. The method of claim 10, further comprising:
reading a cooling system type signal from the motherboard;
determining that the cooling system type signal does not match the model flag value;
posting a message indicating that an incorrect cooling system is installed; and
halting the boot process.

13. The method of claim 10, further comprising:
changing a model flag value when the power switch type signal does not match the model flag value;
setting IHS chassis parameters to match a detected power switch type; and
initiating a reboot process.

14. The method of claim 13, wherein the IHS chassis parameters comprise a model number and a fan control.

15. The method of claim 10, wherein the power switch type signal is read from a power switch connector on the motherboard.

16. The method of claim 12, wherein the cooling system type signal is read from a cooling system connector on the motherboard.

17. The method of claim 12, wherein the power switch type signal and the cooling system type signal are monitored by a motherboard controller.

18. The method of claim 17, wherein the motherboard controller further comprises:
a first input coupled to a pin on a power switch connector and to a first pull-high circuit; and
a second input coupled to a pin on a cooling system connector and to a second pull-high circuit.

19. The method of claim 18, wherein the first input is configured to receive a voltage-high signal when a standard power switch cable is attached to the power switch connector and to receive a voltage-low signal when a remote power switch cable is attached to the power switch connector.

20. The method of claim 18, wherein the second input is configured to receive a voltage-high signal when a standard cooling system type is attached to the cooling system connector and to receive a voltage-low signal when a high-temperature cooling system type is attached to the cooling system connector.
